(19) United States
(12) Patent Application Publication
(10) Pub. No.: US 2017/0352124 A1
(43) Pub. Date: Dec. 7, 2017

(54) METHOD FOR TRANSFERRING RECENTLY BOUGHT GOODS

(71) Applicant: Continental Automotive GmbH, Hannover (DE)

(72) Inventors: Akos SEMSEY, Regensburg (DE); Joris FOKKELMAN, Tegernheim (DE)

(21) Appl. No.: 15/535,911

(22) PCT Filed: Dec. 10, 2015
(86) PCT No.: PCT/EP2015/079191

§ 371 Date: Jun. 14, 2017

(30) Foreign Application Priority Data
Dec. 16, 2014 (DE) 10 2014 226 069.8

(51) Int. Cl. G06Q 50/28; G06Q 20/12; G01C 21/36; B60R 25/20; B60R 25/24; G06Q 20/10

(52) U.S. Cl. CPC G06Q 50/28; B60R 25/24; G06Q 20/108; G01C 21/3685; B60R 25/2018; G06Q 20/12; B60R 2325/108; B60R 2325/205

(57) ABSTRACT

A method for transferring shipments in vehicles, including: a first communications module (M1) for establishing a communication connection to a communications terminal of a supplier which receives authorization data via a communication network (N1); a first identification routine for clearly identifying a supplier; a second communication module (M2) for establishing a communication connection via a wireless communication network (N2) to a communication device of a control device of the access assembly of a vehicle; a second identification routine for clearly identifying the system by the access assembly; a third communication module (M3) for receiving update request information from the driver; and an update routine for updating authorization data in a memory of the system.

### BACKGROUND

The present invention relates to a method for transferring recently purchased goods.

Delivery services that transfer recently purchased goods make great efforts to get from delivery address to delivery address, which takes a lot of time and means that driving profiles for the delivery vehicles are fairly bad.

The term “recently purchased goods” is understood to mean goods that are purchased in a retail store and can be taken from the retail store by a customer in an ordinary purchase process.

A postal recipient of a shipment is the person named in the address for whom a (postal) shipment is intended. This may be a natural or legal person, e.g. an institution, a corporation or a company. A residential address is the postal address of a residence at which a person permanently resides. This may be the main residence or the secondary residence. A residential address normally consists of the indication of the road, the house number, the town and the province. In some cases, the apartment number or room number or the floor, the part of the building (e.g. rear building) and a sublease (“c/o”) are also indicated. For dispatch of recently purchased goods (postal shipments), the residential address also includes the zip code and possibly the town or city quarter. If the residential address is on an estate, then instead of the indication of a road the estate name with the house number is stated.

A postal recipient is also understood to mean the person who actually receives a postal shipment. This person can, but does not have to, be the person addressed (addressee). He may be instructed by the recipient to receive said postal shipment. Postal shipments are ordinarily put into the house mailbox. Certain shipments, such as e.g. those having the shipment form “certified mail” or with a “certificate of delivery”, are normally handed over to the recipient directly, as are telegrams and urgent shipments. Some shipments, e.g. parcels that cannot be handed over, are not placed into the mailbox. In these cases, the recipient receives a notification card.

Vehicles are now frequently equipped with what are known as “keyless entry access units” that allow the vehicle to be unlocked/locked from the outside by radio. This requires a control unit located in the motor vehicle, which uses radio signals to communicate with an external unit that is in most cases integrated in a key or in an authorization card for the vehicle. The control unit in the vehicle and the external unit, also called an external identification unit, which the driver usually carries, enter radio contact after both have been activated. The two units then use radio to interchange data that contain a stored code. If this code matches between the identification unit and the control unit, then the vehicle is unlocked or locked by the authorized driver.

The purchased goods are ordinarily transferred to the residential address of the relevant person in the case of orders over the Internet or by telephone or catalogue, as is performed e.g. by delivery services. A recipient of a perishable shipment is the person stated in the address for whom a (postal) shipment is intended. This may be a natural or legal person, e.g. an institution, a corporation or a company.

It is an object of the invention to provide delivery of recently purchased goods using lower logistical complexity.

### BRIEF SUMMARY

The object is achieved by the features of the inventive method according to claim 1.

Quite generally, the inventive method can be summarized in the manner that a customer or the drivers park the car in a parking lot as normal. In this case, the parking location is recorded. The drivers and the passengers go shopping, e.g. on foot or by public shared transfer. At the destination, such as e.g. in a pedestrian zone or a shopping center, the items or purchasable goods can be bought wholly or partly based on samples such that the buyer has the merchandise delivered not to hand but rather to his automobile.

This dispenses with the need to warehouse the purchasable goods or the merchandise, apart from the sample parts, in the retail store. Preferably, the warehousing is concentrated close to the parking lot as an underground robotized warehouse system with few employees, who transport the automatically compiled parcels to the automobiles and pack them using the access code.

This approach allows complete isolation and better optimization of the premises of service providers and representative common rooms of warehouse systems and parking lots. The drivers or customers no longer have to carry full shopping carts and bags from store to store, but rather can take a break in order to take a coffee or pizza break at the end of shopping so that the merchandise still has some time to get to the automobile.

In one advantageous configuration, an online shop can be carried out during a journey by airplane or train, the purchased merchandise being packed into the vehicle at the P+R parking lot at the end no later than by the time the driver is at his automobile again.

A particular advantage is use for regular shopping for food and/or beverages that is done online. In this regard, there is provision for the assistance of a stored user profile, where the items that regularly need to be obtained are managed, to be used to subsequently deliver the purchased merchandise to the automobile in the company parking lot. This advantageously allows new options to be developed for beverage stores and food stores. Large companies that employ several thousand employees who park in well-defined parking lot areas on a daily basis can use the inventive method very efficiently and hence support flexibility of the employees. For merchandise that requires cooling, it is being considered for delivery times to be arranged to be shortly before the end of work.

Advantageously, the vehicle can simply be left in public parking lots or shopping parking lots. As already described, the service providers obtain the access code from the driver by virtue of the transaction of a purchase, and the service provider can deliver the purchased goods. The approach that only samples need to be kept in a retail store advantageously saves warehouse space and hence rental costs in expensive locations at which the stores are located, since just a sample or even only a picture is required for the customer to see. The store area required is reduced drastically. The customer-friendly and hence energy-inefficient exhibition of frozen foods is converted to one central large cold storage cell and also does not need to be kept in the shopping street.

This approach is particularly advantageously suitable for standard items where all specimens are identical. Selection of the merchandise by the customer can take place at home, using a smartphone or on a very small store area. The purchased goods are delivered to the vehicle or collected from a central point.

The automobile provides a reliable and secure way for the service provider to gain access to the vehicle, and theft prevention is critically activated in this case. This involves the use of a changing code method that can be used only in one time window and only by the delivery service and lapses after single use. The automobile must obtain the changing code from the employee of the delivery service, said changing code being checked to determine whether it comes from the delivery service. An input can be transmitted by typing it in or from a mobile using a secure channel.

The automobile or the driver or a parking garage management system provides notification of when and where the automobile is located so that the purchased goods can be received. There is provision for the locking apparatuses to be opened using the special individual changing code.

In one advantageous configuration of the inventive method for transferring recently purchased goods in vehicles, the position of the vehicle is ascertained by means of a positioning system in the vehicle. Subsequently, the clearance for a position of the parked vehicle as a delivery address is provided to a system via a communication unit of the vehicle via a communication network. Thereafter, the position of the parked vehicle is transmitted via a communication unit of a controller of the access arrangement via a communication network and the authorization clearance for opening of at least one door and/or a trunk of the vehicle by a deliverer is transmitted via a communication device of a server via a communication network to the communication terminal of the deliverer, and the radio signal contains the authorization clearance, wherein opening is valid within a particular time window. Subsequently, a radio signal that contains an authorization clearance is transmitted, wherein the access arrangement activates opening of at least one door and/or a trunk of the vehicle when there is authorization, and opening and transfer of the shipment by manual closing of a door and/or of the trunk of the vehicle by the deliverer, once performed, are followed by the transfer of the shipment being confirmed by the deliverer via the communication device via the communication network to the communication terminal of the driver of the vehicle via the system, and transmission of an update request by the communication device of the driver of the vehicle is followed by an update being performed for authorization data in the controller of the access arrangement. In this regard, the transmission of the authorization clearance is effected electronically by the transaction of a purchase of the good in a retail store via the payment process and, during the payment process, consent for the delivery to be made to the vehicle of the driver.

In a further advantageous configuration, the payment process is effected by means of a money card or using the communication terminal of the driver with an associated payment application.

In a further advantageous configuration, the payment process is effected by means of home banking.

In one advantageous configuration, notification of the delivery can be provided by virtue of the vehicle using the communication device to transmit an SMS, email or another electronic communication to the driver as a data packet via the communication network N2 to the communication terminal about the successful delivery or deliveries that have not been made within the prescribed time window. When the driver opens the vehicle, the access arrangement provides him with a short communication, which is presented audibly or visibly on the screen of the communication terminal, indicating that a new delivery has been received or a parcel has been collected at a particular time. For the output that a delivery has been made, the intention according to the invention is that a warning is output on alighting if, by way of example, there is still delivered merchandise in the trunk. This is intended to remind the driver not to forget the delivered merchandise in the vehicle on leaving the vehicle.

In a further advantageous configuration, the delivery that has been made is confirmed by virtue of the vehicle, following a delivery and locking of the trunk or the doors, delivering a confirmation to the system in order to signal that the vehicle is locked again. If the vehicle is not locked again within a period of time, the communication terminal of the deliverer receives a warning communication via the system indicating that the vehicle is not properly locked.

The intention according to the invention is for visual, audible or sensory documentation of the delivery to be provided using an onboard camera. In this regard, the intention is that, when the vehicle is opened, cameras situated in the vehicle that are installed in the vehicle for these or other purposes take photographs or film recordings and are triggered by the access arrangement. The intention is also for cameras to be installed in the trunk.

A particular advantage is the use of cameras that are installed for blind spot detection, parking assistance, assistance for adaptive restraining systems, sleep warning systems or other purposes, and are actuated by the access arrangement when the trunk or the doors are opened. The films or photographs can prevent or resolve any cases of misuse. Sensor values from acceleration sensors or what are known as structure-borne sound sensors or microphone signals are likewise used for documentation purposes for transfer of the shipment having been effected.

In a further advantageous configuration, the position of at least one vacant parking area is computed, based on vehicle-to-vehicle and/or vehicle-to-infrastructure communication, from the current position of the vehicle and transmitted to a navigation apparatus of the vehicle. In this case, the navigation apparatus can transmit the position to the system via the communication devices.

A further configuration of the inventive method is distinguished in that the position of the vacant parking area is transmitted to the navigation apparatus when the vehicle is located in a previously defined area in relation to the vacant parking area, preferably close to a barrier of a parking facility.

One very advantageous configuration is characterized in that parking of the vehicle on a selected vacant parking area is followed by the position of the selected parking area being transmitted to a storage medium, which is preferably transportable by the driver, preferably a key of the vehicle and/or a mobile phone of the driver and/or a chip card, then stored on the storage medium and preferably additionally displayed.

One advantageous configuration is distinguished in that the navigation apparatus or the storage medium transmits the position of the selected parking area to the system via a parking lot management system of the parking facility.

In a further configuration, when the selected parking area is left, the position of the parking area that is now vacant again is transmitted to the system via the parking lot management system of the parking facility.

In a further advantageous configuration, the position of the at least one vacant parking area is computed from a distance measurement from at least one vehicle or at least one infrastructure element to other vehicles or to other infrastructure elements that are arranged within an area having a previously stipulated radius around the vehicle looking for a vacant parking area.

One advantageous configuration is characterized in that further information pertaining to the parking area situation, preferably about residents' parking zones or no-stopping zones, is transmitted by the at least one infrastructure element and/or provided from a digital map of the navigation apparatus and used to compute the position of the at least one vacant parking area.

In a further configuration, the deliverer is identified by voice recognition, by transmission of a piece of identification information—PIN/TAN—, or by a challenge-response method. A further configuration is characterized in that the system is identified by the use of a piece of explicit cryptographic information.

In a further particularly advantageous embodiment, the communication link via the wireless communication network N2 is set up via a mobile radio communication network and/or WLAN network.

In a further advantageous configuration, the communication between the communication device of the system and communication device of the access arrangement and the communication device of the deliverer is encrypted by using a shared secret.

A further advantageous configuration is distinguished in that, during or before parking of the vehicle, a set of access codes or code segments thereof for later opening of the vehicle by a delivery service is transmitted to a storage medium, which is preferably transportable by the driver, preferably a key of the vehicle and/or a mobile phone of the driver and/or a chip card, then stored on the storage medium and preferably additionally displayed.

An advantage of the inventive method is that this management of whereabouts of the vehicles to be located is used to produce logistical synergistic effects, since a high level of automation is provided for the transfer of the shipments to the relevant vehicles. For a delivery service, the invention is used to attain a reduced level of involvement for the delivery time and energy consumption with all the environmentally friendly side effects.

A further aspect of the invention is that a communication link is set up between an authorized deliverer, who obtains the applicable authorization data from the inventive system, and the access apparatus of the vehicle. When the system or the mobile terminal of the deliverer has been successfully identified, the authorization data in the controller of the access arrangement for the transfer process of the deliverer are updated and are activated as appropriate, so that the deliverer is provided with approval for the shipment in the trunk or in the passenger compartment by virtue of authorized approval of opening of the vehicle doors or tailgate of the trunk by means of the controller, so that the shipment can be safely transferred in this case. According to the invention, the trunk is the place in the vehicle that is provided for transporting cargo. Normally, it is at the rear, but some vehicle types have it at the front. The passenger compartment referred to in motor vehicle engineering is the space that contains the vehicle occupants.

In addition, the method can, after being initiated by the driver, take place on the system in fully automated fashion, that is to say quickly and without cost-incurring use of personnel. The use of an existing mobile radio infrastructure and the option of implementing this largely using commercially available server components also reduce costs. Furthermore, the automation minimizes the risk of incorrect inputs. A further advantage of the invention is the opportunity for the update to the authorization data to be able to be effected directly using a mobile terminal of the driver and of the deliverer.

The inventive vehicle provides a reliable and secure way for a deliverer to be able to open e.g. the trunk without this critically compromising theft prevention, however. It is possible for a changing code method to be used, this being able to be used once only by the deliverer only in one time window and elapsing after single use.

The vehicle or the driver uses communication links to register in an infrastructure unit, such as e.g. a parking lot management system, connected to the inventive system, this registering involving communication of when and where the vehicle is parked to the inventive system in order to be able to accept a shipment from a deliverer. In this case, the infrastructure and the resultant information service advantageously ensure that the deliveries can be transferred by the delivery service through optimized bundling of shipments.

As a result of the transmission of the authorization to open the relevant vehicle, it is also intended that transmission of the authorization from the mobile terminal of the deliverer or the delivery vehicle networked thereto prompts all vehicles nearby that are expecting a delivery to react to the radio signal produced by the deliverer with a light signal. This facilitates location by the deliverer, in order to find the relevant vehicles quickly, wherein, as already mentioned, it is possible to open the trunk or the doors only with the specific individual changing code.

Further advantageous developments of the inventive method for transferring recently purchased goods can be found in the further claims.

The inventive method is explained in more detail below.

### BRIEF DESCRIPTION OF THE DRAWINGS

FIG. 1 shows a system for transferring shipments.

FIG. 2 depicts a vehicle looking for a parking spot.

FIG. 3 depicts a method for finding parking spaces along a road for determining a delivery location.

FIG. 4 is a schematic depiction of an access arrangement in which an update to the authorization data is initiated via a deliverer's mobile radio telephone.

FIG. 5 schematically shows a system for transferring shipments.

### DETAILED DESCRIPTION

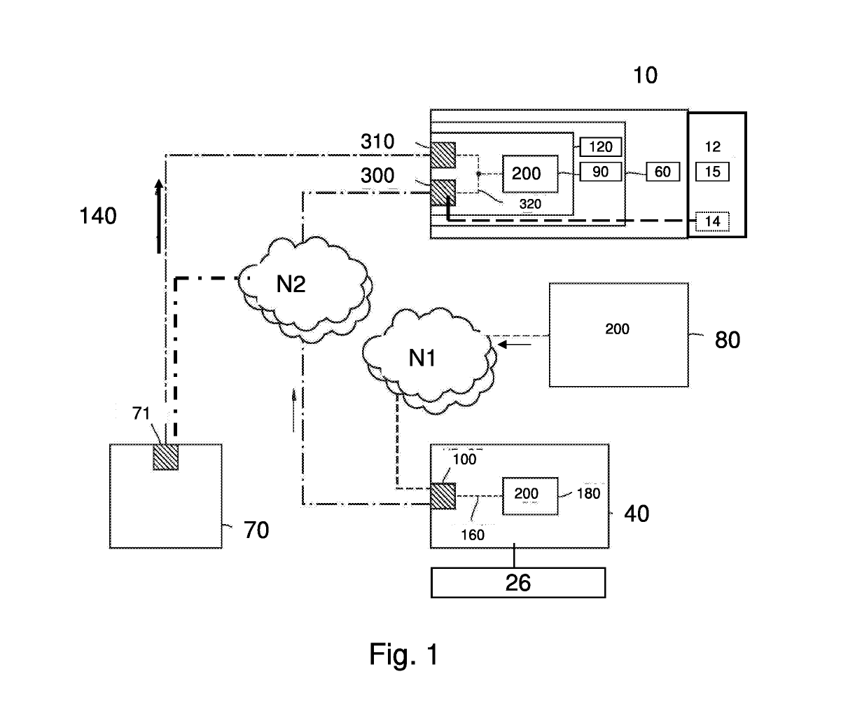

A vehicle 10 depicted in FIG. 1, for example a car or truck, which is intended to be parked on a parking area, is equipped with a positioning system, for example a GPS system 12, that contains a computation apparatus 14 and a navigation apparatus 15. FIG. 1 shows a system 40 for transferring shipments. To this end, an update is performed for authorization data 200 for an access arrangement 60 of a vehicle 10 and a communication terminal 70 of the deliverer. The system 40 may be a server-based solution that has the standard components and peripherals, such as processor, memory, network connection, operating system, application software, etc.—not depicted. In addition, a first communication network N1 and a second communication network N2 are portrayed.

After the driver has parked his vehicle and the position of the vehicle is located, he goes into the retail stores in order to get the goods that are to be purchased. When a particular purchasable good is then selected, the payment process takes place. This can be done without cash or using cash. Cashless payment transactions involve the information about the location of the vehicle being ascertained; during the transaction, electronic payment transactions comprise the process of cashless payment transactions, payment by means of payment card, home banking. It is also possible for the transaction to be performed by means of the mobile terminal that the driver carries. During the transaction, the location statement is transmitted to the delivery service that will deliver the merchandise that is to be expected to the vehicle.

The communication terminal 70 of the deliverer is, by way of example, a mobile radio terminal, a multifunctional smartphone, a chip card or a similar terminal with radio communication capability having a memory, said terminal having at least one communication device 71. The system 40 has a communication device 100 that the system 40 can use to communicate both with the communication network N1 and with the communication network N2. Furthermore, the communication device 100 in the system 40 is connected to a data module 180 via a data bus 160 using relevant communication protocols. This data module 180 or another competent device has originally allocated or managed the authorization data 200. The communication terminal 80 of the driver is likewise connected to the communication network N1, for example wirelessly.

The vehicle 10 has an access arrangement 60. This access arrangement 60 has a controller 120. This controller 120 is connected to the communication network N2 via a communication device 300. Likewise in the controller 120, a memory 90 stores the authorization data 200 of authorized deliverers for the access arrangement 60. Furthermore, there is a control line to a power source 130 and to the air conditioning system 140 in the vehicle 10.

Also depicted is the mobile terminal or communication terminal of the deliverer 70, which has a communication device 71. This mobile terminal can be used to transmit, via the communication device 71 thereof, an encoded and encrypted radio signal 140 to a communication device 310 of the controller 120 of the access arrangement 60. The radio signal is understood to mean a communication signal, which is based on electromagnetic signals, including optical signals (e.g. infrared light). The vehicle 10 reacts to a particular encrypted radio signal 140 from the communication terminal 70 of the deliverer, which is preferably limited to a particular time window and canceled following use of the opening command. The radio signal 140 provides access authorization, but not driving authorization to start the vehicle. An active alarm system, not shown, is modified, according to the invention, for the period of authorized transfer of the shipment to the vehicle 10 so that an alarm is not triggered.

The radio signal 140 can be used to initiate different functions of the access arrangement 60. These may be the opening or closing of the door locking system or the trunk locking system, for example. In this case, particular information is associated with the communication terminal 70 of the deliverer and particular user data 200 are associated with the controller 120, for example by the data module 180 of the system, and stored. These only allow the access arrangement 60 of a particular vehicle 10 to be operated using a particular communication terminal 70 of the deliverer. The memory 90 and the communication devices 300 and 310 are connected to one another via a data bus 320 using relevant communication protocols.

In the radio signal, data packets are transmitted that can comprise, as a first data element, a vehicle identification, the vehicle color, vehicle type, vehicle registration, a digital identification code, a telephone number, can comprise, as a second data element, the vehicle position or a URL for a service, such as an IP-based parking lot management system 26, where the vehicle position can be requested, and can comprise, as a third data element, an access code that allows profiled access for the deliverer, but does not provide driving authorization and becomes invalid after a particular time. Alternatively, further data fields are used, such as “search code”, “approval for door opening”, “shipment requires cooling after the vehicle is opened”.

When the data field “shipment requires cooling after the vehicle is opened” has been set, the controller 120 can then be used to activate the power source 130 or to activate the air conditioning system 140. The activation is dependent on the type of the perishable shipment. If the type of the perishable shipment has a temperature range indicated for it, such as e.g. 10° C.-20° C., the air conditioning system is activated by the controller and the perishable shipment can then be placed in the passenger compartment by means of access via a door.

The communication terminal 80 of the driver, which is likewise a mobile, smartphone, a multifunction automobile key or a chip card, contains or receives from the vehicle 10 via the system 40 a particular number of access codes that can be used by the driver e.g. when shopping. When the driver wishes to pay for something and have it delivered, an access code for the vehicle 10 is communicated to the system 40 via the communication network N1 or N2 from the communication terminal 70 of the driver to a device at the checkout of the relevant retail store. In this case, the access codes can have a validity period of a few hours and can no longer be used after said hours have elapsed.

In this variant of the allocation of the authorization, the vehicle 10 does not necessarily have to be networked directly to the environment. The access codes prepared in the communication terminal 80 of the driver become valid on alighting by determining the period for the alighting time plus x hours, x hours being the period of residence in the parking lot for the duration of shopping that the driver inputs in a predetermined manner using a human-machine interface (HMI), not depicted, of the vehicle 10 and that is then transmitted to the communication terminal of the driver 80.

After the authorized deliverer has been explicitly identified, the authorization data 200 are then used to set up a communication link from the communication device 100 of the system 40 to the communication device 300 of the controller of the access arrangement 60 via the communication network N2.

The communication terminal 70 of the deliverer is now explicitly identified by the controller 120 of the access arrangement 60. This can be done by using an explicit cryptographic key, for example. This does not require this step to take place at a time immediately after the identification of the deliverer and the stipulation of the requirement update.

One possibility for the identification and authentication of the communication terminal 70 of the deliverer by the controller 120 of the access arrangement 60 is a challenge/response method, for example. This requires the controller 120 of the access arrangement 60 and the communication terminal 70 of the deliverer to have a shared cryptographic secret. This secret is expediently generated when the driver first registers with the system 40, either by the controller of the access arrangement 60 or by the system. The secret is then stored in the memory 90 in the controller 120 and in a memory 90 in the system. After the communication between the communication terminal 70 of the deliverer and the controller SG via the communication network N2 is started, the controller 120 will send a challenge to the system and the communication terminal 70 of the deliverer, from which the system and the communication terminal 70 of the deliverer compute the response using the cryptographic secret and return said response to the controller SG of the access arrangement 60 via the communication network N2. This method moreover has the advantage that the subsequent further communication between the system, communication terminal 70 of the deliverer and the controller 120 via the communication network N2 for transmitting the update request 700 can also proceed in a manner encrypted using the shared secret, and it is therefore not a requirement for the protocols being executed via the communication network N2 to provide adequate data integrity per se.

The simpler method of identification and authentication of the system by the controller of the access arrangement 60 is to use a PIN code possibly together with a one-time usable TAN code. These codes, that is to say PIN and possibly a sufficient quantity of TAN codes, are expediently generated when the driver first registers with the system 40, either by the controller 120 of the access arrangement 60 or by the system 40, and are stored in the memory 90 of the controller 120 and in the system 40. In this case, the communication takes place in unencrypted form, and it is a requirement that the protocols being executed via the communication network N2 provide adequate data integrity.

Alternatively, the radio signal can be split between the communication terminal 80 of the driver and the communication terminal of the deliverer 70 such that the transmitted data packets between driver and deliverer are stored in the access arrangement 60, so that the data packet is transmitted in part by the driver's mobile or email or comparable technology, in part with the deliverer and the two packet elements yield an access code or authorization data 200 only together. This method advantageously prevents an access code from being monitored during the transmission and the vehicle 10 from being opened without authorization.

In one variant of this method, the system 40 itself stores no identification data. Rather, the system 40 transmits the identification data of the deliverer to the controller 120 after the communication between system and controller 120 has been set up.

In this case, the identification data (e.g. PIN code and TAN codes) are firstly stored in the memory SP of the controller 120. Secondly, they are known to the deliverer or, by way of example, stored in a memory 90 in his communication terminal 70.

Following explicit identification of the system 40 to the controller 120, the update request 700 from the driver is transmitted from the communication device 100 of the system via the communication network N2 to the communication device 300 of the controller 120. An update is then performed for the authorization data 200 in the memory 90 of the controller 120 of the access arrangement 60 in accordance with the update request 700.

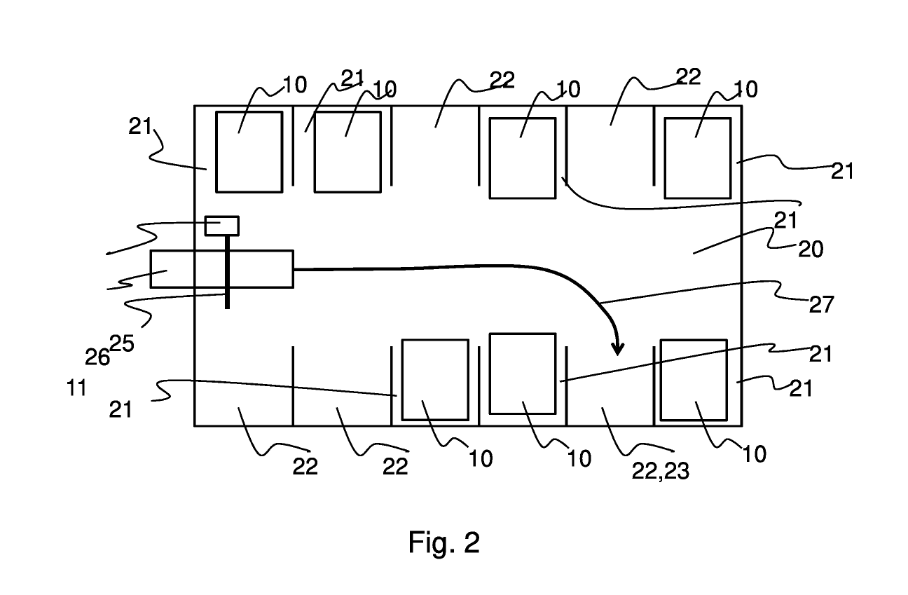

FIG. 2 depicts a vehicle looking for a parking spot. When a vehicle 11 arriving in a parking facility, for example in a parking garage 20 depicted in FIG. 2, looks for a parking area, the vehicle is initially at an entrance barrier 25 to the parking garage 20. The arriving vehicle 11 has similar equipment to the vehicle 10 depicted in FIG. 1.

The parking garage 20 has parking areas 21 that are occupied by vehicles 10. By contrast, the parking areas 22 are vacant, which means that it is possible to park on them.

At the entrance barrier 25 of the parking garage 20, short range radio (e.g. infrared, Bluetooth, DSRC, ITS-G5, W-LAN, etc.) is used to transmit information about which parking areas 22 are vacant from the parking lot management system 26 integrated in the entrance barrier 25 to the computation apparatus 14 of the vehicle 11 via the communication link, i.e. by means of vehicle-to-infrastructure communication, via the communication devices 300/310. The positions of the vacant parking areas 22 can be indicated, by way of example, as absolute positions of the GPS system 12 or as relative positions, e.g. in relation to the position of the barrier 25.

The GPS system 12 is put into what is known as parking garage mode following the transmission of the information about vacant parking areas 22. On the basis of the data transmitted by the parking garage, the computation apparatus 14 now computes the positions of the vacant parking areas 22 in the reference system of the vehicle's own GPS system 12 and presents these to the driver on a specific display provided for this mode. The driver can now select a parking area that is suitable for him for his vehicle 11 and confirm clearance for this position as a delivery location.

The navigation apparatus 15, which receives the computed position data from the computation apparatus 14, can subsequently be used to ascertain route guidance to a parking area 23 selected by the driver, for example, and to provide said route guidance for the driver. The driver subsequently moves his vehicle on the basis of the computed route guidance 27 to the selected parking area 23 and parks his vehicle 11 thereon. The route guidance is advantageous particularly in large, confusing and highly frequented parking facilities, for example multistory parking garages.

When the vehicle 11 is now parked on the selected parking area 23 in the parking garage, the navigation apparatus 15 of the vehicle 11 stores its position. This function can be triggered e.g. by the engine being switched off at the position of the selected parking area 23. The recorded position of the now occupied parking area 23 is transmitted by the navigation apparatus 15 to the memory 90, or via the communication device 300 to the system 40 and the key of the vehicle, to a mobile phone of the driver or to another device (e.g. chip card) having a preferably wireless communication option for the driver 80. The position of the parking area 23 can be displayed on the storage medium in the communication terminal 80 of the driver on request. This allows the driver to find his vehicle 11 more quickly when returning to it.

The driver now leaves the parking garage 20. At the exit, the system 26 records, e.g. by interrogating the storage medium, the parking area that the vehicle 11 is on. Since the storage medium has stored the position of the vehicle 11 and of the selected parking area 23, it transfers said position to the parking lot management system 26 of the parking garage 20. The parking lot management system 26 now knows that the parking area 23 selected by the driver, the position of which has been transmitted to the parking lot management system 26, is occupied. The parking lot management system 26 also transmits this position to the system 40 for verification, since this once again checks whether the vehicle is actually located where the driver parked it on confirming said position as a delivery location.

After some time, the driver returns to the parking garage 20 in order to drive on in his vehicle 11. Alternatively, the driver can also type/enter the alphanumeric parking mark indicated at the parking spot, which the driver identified when parking the vehicle, directly into the memory of his communication terminal 80.

In a preferred exemplary embodiment, there are, in the parking garage 20, a multiplicity of reading points to which the position of the vehicle 11 can be transmitted from the storage medium. One such reading point is located at the barrier 25 and/or on the doors and/or automatic tellers of the parking garage, for example. At the request of the driver, such a reading point is used to display the position of the vehicle 11 and if need be the way to it, so that the driver his vehicle 11 can transmit the position of the parked vehicle to the delivery service and the driver can quickly find his vehicle. The position of the vehicle 11 on the parking area 23, which position is stored in the navigation apparatus 15, is preferably also used as a starting position for the next route that is computed by the navigation apparatus 15. The position of the parking area 23 that has become vacant is transmitted to the parking garage management system 26 by the storage medium or the navigation apparatus 15 by short range radio when the vehicle 11 exits. The parking lot management system 26 now knows that the applicable parking area 23 on which the vehicle 11 had previously parked is now vacant again.

Instead of the short range communication with the parking garage management system 26, it is also possible for communication with an applicable parking lot management server via GPS, UMTS, LTE, Wi-Max, W-LAN etc. to take place.

The proposed method can be implemented with comparatively little technical complexity and without additional hardware in the vehicle.

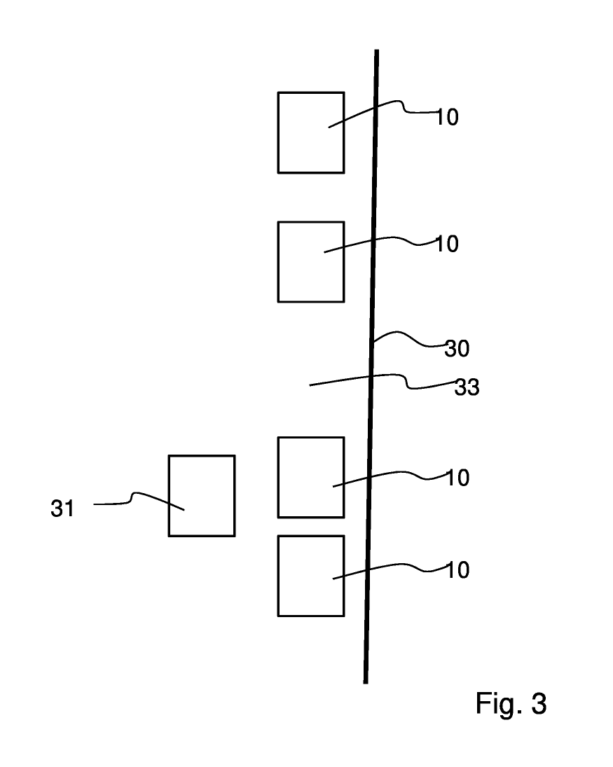

A further exemplary embodiment, depicted with reference to FIG. 3, explains how the position finding for the delivery location statement can take place in the downtown region of large cities.

The method depicted by means of FIG. 3 is used for finding parking spaces, for example at the edge 30 of a road, and hence for determining a delivery location. In this case, many vehicles 10 are parked, which correspond to the vehicle 10 depicted in FIG. 1. The vehicle 31 looking for a parking area also has an identical design.

To implement the inventive method, it is advantageous if the vehicles 10, 31 have distance sensors that are mounted at the front, rear or sides of the vehicles 10, 31 involved, such as, by way of example, ultrasonic sensors, infrared sensors, radar sensors, camera, etc. The computation unit 14 can further be used by the vehicles 10, 31 to perform vehicle-to-vehicle communication and/or vehicle-to-infrastructure communication via the communication devices 300/310. Further, there is a navigation apparatus 15.

While looking for a parking spot, the driver of the searching vehicle 31 first of all uses a key or a command to set up a connection to vehicles 10 in a vicinity with a previously defined radius around the vehicle 31. This “wakes” the already parked vehicles 10 in the vicinity from what is known as a sleep mode (inactive state) and puts them into the active state. The vehicles 10 now in the active state then measure their distances from the next particular vehicle 10 or from the next infrastructure device (not depicted), for example a set of traffic lights or a road sign, at the front, rear and/or at the sides.

Vehicle-to-vehicle communication is used to transmit the ascertained distance data from the vehicles 10 in the vicinity to the computation apparatus 14 of the vehicle 31 looking for a parking area. Further, the positions of the respective vehicles 10 are transmitted to the computation apparatus 14 of this vehicle 31. The computation apparatus 14 of the GPS system 12 can now use the information transmitted by C2C communication to establish the particular area available for parking. If said area is sufficiently large, then the corresponding vacant space is identified as a parking area and displayed to the driver as a parking area available for parking. In the situation depicted in FIG. 3, the parking space 33 is one such parking area. After the vehicle 10 has occupied the parking spot, the communication device 300 is used to transmit this position from the GPS system 12 to the system 40.

The navigation apparatus 15 can use the data ascertained by the computation apparatus 14 to compute the route from the current position of the vehicle 31 looking for a parking area to the vacant parking area 33 and can make said route available to the driver for the purpose of quickly finding the parking space. If there are multiple vacant parking areas in the vicinity of the vehicle 31, they can be presented on a display of the computation apparatus 14, so that the driver can select a parking area that is suitable for him.

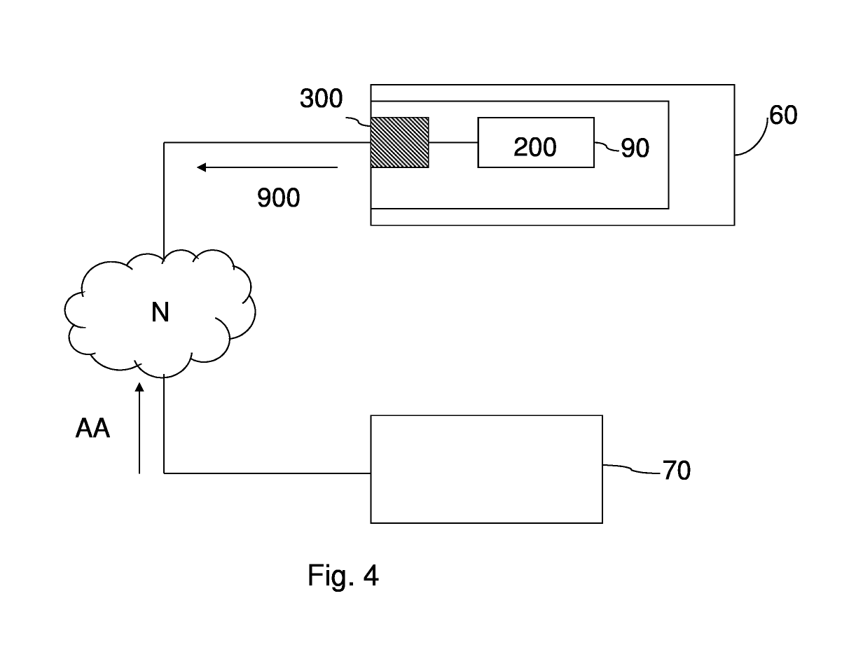

FIG. 4 shows a schematic depiction of an access arrangement 60 for the inventive method, in the case of which the update to the authorization data 200 is initiated via a mobile radio telephone 70 of the deliverer. Also depicted are a mobile radio communication network N, the access arrangement 60, the controller 120, the memory SP and the communication device 300 of the controller 120.

According to the invention, this exemplary embodiment allows the authorized deliverer to update the authorization data 200 of the access arrangement 60 even without using a service center. To this end, the mobile radio terminal 70 of the authorized deliverer first of all sets up a connection via the mobile radio communication network N to the communication device 300/310 of the access arrangement 60. The authorized deliverer is then explicitly identified. This can be done in various ways. According to the invention, the controller 100 can generate an authorization code 900 and send it via the communication device 300/310 to the mobile radio terminal 70 of the authorized deliverer, for example as a short message—SMS. This authorization code 900 is stored in the mobile radio terminal 70 in a memory or on the SIM card thereof (not depicted). When it is desired for the user data 200 to be updated, this authorization code 900 needs to be returned to the communication device 300. According to the invention, a two-part identification can then take place. To this end, a check is first of all performed to determine whether the authorization code 900 has been sent by a known mobile radio terminal 70 or the SIM card thereof. If this is the case, the authorization code 900 sent by the mobile radio 70 is then checked by the controller 120 of the access arrangement 60 in a second step. If the outcome of this check is positive, then the authorization data 200 are updated, e.g. erased, in the controller 120 in accordance with the request 700.

This method for identifying the deliverer can also be safeguarded still further by virtue of the communication device of the controller 300/310, having received the authorization code, sending a request, for example as a short message—SMS—, to an address (phone number) of a mobile radio previously stored in the controller 120 or in the communication device of the controller 310/300, which address then needs to be confirmed within a time window, e.g. again by a short message with an authorization code to the communication device of the controller 310/300.

A further possible identification method is the use of a challenge/response method, which is described above in detail, wherein a shared secret is interchanged in advance between the controller 120, the access arrangement 60 and the mobile radio terminal 70 of the deliverer or the SIM card thereof. In this case, the mobile radio terminal 70 of the deliverer needs to authenticate itself to the access arrangement 60.

Use of the methods described above is advantageous not only for erasing user data 200 from the memory SP but also for reactivating user data 200.

According to the invention, the methods described can also be applied to RKE—remote keyless entry—keys or engine immobilizers.

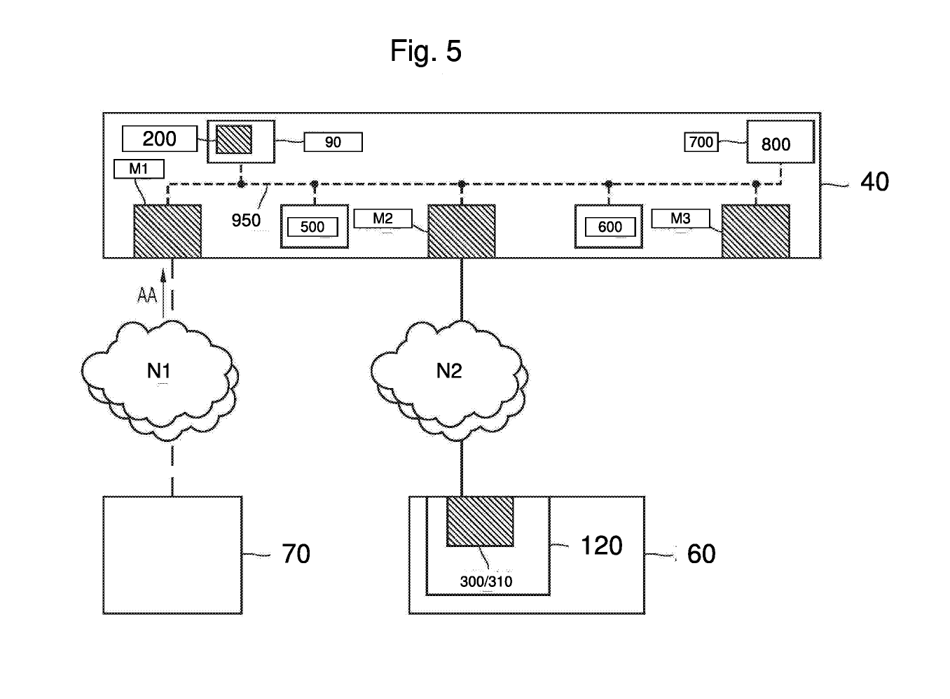

FIG. 5 schematically shows a system for transferring shipments. The system has a memory 90 and authorization data 200 stored therein. The memory 90 is connected via a data bus 950 to a first identification module that allows a first identification routine 500. Moreover, this data bus 950 has a second identification module and an update module 700 connected to it, which allow a second identification routine 600 and an update routine 800. Finally, the system has at least three communication modules M1, M2 and M3. The first communication module M1 can be used to set up a communication link from the communication terminal 70 of a deliverer via a mobile radio communication network N1. The second communication module M2 can set up a communication link to the controller 120 of the access arrangement 60 via a second communication network N2 using the communication device 300/310 of said controller.

Again, it is possible according to the invention for the authorized deliverer of the authorization data 200 to use his communication terminal 70 to set up a communication link to the system 40 via the communication network N1 using the communication device 100 of said system. This is done using the communication-network-specific protocols of the communication network N1. The first identification routine 500 is then used to identify the authorized deliverer using one of the identification methods described above. The deliverer then uses his communication terminal 70 to transmit an update request 700 to the system. Thereafter, the second communication module M2 is used to set up a mobile radio link to the controller 120 of the access arrangement 60 via the mobile radio communication network N2 using the communication device 300/310 of said controller.

The system is now explicitly identified by the controller 120. This is done using the second identification routine 600. This can involve one of the methods for identification described above being used.

Once identification has taken place, the authorization data 200 are updated both in the controller 120 and in the memory 90 of the system. This is done using the update routine 800. In this case, the update is made in accordance with the update request 700 from the authorized deliverer.

Neither the inventive method nor the inventive arrangement is restricted to the exemplary embodiments, but rather they can be used in all access arrangements, e.g. for buildings or electrical devices, that have communication devices for communication via communication networks. In this case, the communication devices need to be coordinated with the communication networks and identification methods used.

1. A method for transferring recently purchased goods in vehicles, wherein the steps of:
ascertainment of the position of the vehicle, by means of a positioning system in the vehicle,
clearance for a position of the parked vehicle as a delivery address to a system 44-via a communication unit of the vehicle via a communication network (N2),
transmission of the position of the parked vehicle via a communication unit of a controller of the access arrangement via a communication network (N2),
transmission of the authorization clearance for opening of at least one door and/or a trunk of the vehicle by a deliverer of a shipment via a communication device of a server via a communication network (N1) to the communication terminal of the deliverer of a shipment, and the radio signal contains the authorization clearance, wherein opening is valid within a particular time window,
transmission of a radio signal that contains an authorization clearance, wherein the access arrangement activates opening of at least one door and/or a trunk of the vehicle when there is authorization,
opening and transfer of the shipment by manual closing of a door and/or of the trunk of the vehicle by the deliverer, once performed, are followed by the transfer of the shipment being confirmed by the deliverer via the communication device via the communication network (N2) to the communication terminal of the driver of the vehicle via the system, and
transmission of an update request (AA) by the communication device of the driver of the vehicle is followed by an update being performed for authorization data in the controller of the access arrangement, are performed,
characterized in that the transmission of the authorization clearance is effected electronically by the transaction of a purchase of a good in a retail store via the payment process and, during the payment process, consent for the delivery to be made to the vehicle of the driver of the vehicle.

2. The method as claimed in claim 1, characterized in that the payment process is effected by means of a money card or using the communication terminal of the driver with an associated payment application.

3. The method as claimed in claim 2, characterized in that the payment process is effected by means of home banking.

4. The method as claimed in claim 3, characterized in that parking of the vehicle on a selected vacant parking area is followed by the position of the selected parking area being transmitted to a storage medium, which is preferably transportable by the driver, preferably a key of the vehicle and/or a mobile phone of the driver and/or a chip card, then stored on the storage medium and preferably additionally displayed.

5. The method as claimed in claim 4, characterized in that the navigation apparatus or the storage medium transmits the position of the selected parking area to a parking lot management system of the parking facility.

6. The method as claimed in claim 5, characterized in that when the selected parking area is left, the position of the parking area that is now vacant again is transmitted to the system via the parking lot management system of the parking facility.

7. The method as claimed in claim 6, characterized in that the position of the at least one vacant parking area is computed from a distance measurement from at least one vehicle or at least one infrastructure element to other vehicles or to other infrastructure elements that are arranged within a vicinity having a previously stipulated radius around the vehicle looking for a vacant parking area.

8. The method as claimed in claim 7, characterized in that further information pertaining to the parking area situation, preferably about residents' parking zones or no-stopping zones, is transmitted by the at least one infrastructure element and/or provided from a digital map of the navigation apparatus and used to compute the position of the at least one vacant parking area.

9. The method as claimed in claim 8, characterized in that the deliverer is identified by voice recognition, by transmission of a piece of identification information—PIN/TAN—or by a challenge-response method.

10. The method as claimed in claim 9, characterized in that the system is identified by the use of a piece of explicit cryptographic information.

11. The method as claimed in claim 10, characterized in that the communication link via the wireless communication network (N2) is set up via a mobile radio communication network and/or WLAN network.

12. The method as claimed in claim 11, characterized in that the communication between the communication modules (M1, M2, M3) of the system and communication device of the controller of the access arrangement and the communication terminal of the deliverer is encrypted by using a shared secret.

13. The method as claimed in claim 12, characterized in that, during or before parking of the vehicle, a set of access codes or code segments thereof for later opening of the vehicle by a delivery service is transmitted to a storage medium, which is transportable by the driver, in the form of a key of the vehicle and/or a mobile phone of the driver and/or a chip card, then stored on the storage medium and additionally displayed.
